(19) United States
(12) Patent Application Publication
(10) Pub. No.: US 2004/0065667 A1
(43) Pub. Date: Apr. 8, 2004

(54) Single walled insulating vacuum envelope (SWIVE)

(76) Inventor: Thomas G. Steketee, Los Angeles, CA (US)

Correspondence Address: THOMAS STEKETEE, 7095 HOLLYWOOD BL., #1327, LOS ANGELES, CA, 90028, US

(21) Appl. No.: 10/065,318

(22) Filed: Oct. 2, 2002

(51) Int. Cl. B32B 1/02; B65D 1/00; B65D 83/72

(52) U.S. Cl. 220/592.27; 428/34.1

(57) ABSTRACT

A vacuum filled shipping or storage container with a pliable external covering supported by an interior framework designed to minimize contact points for heat conduction towards the materials to be stored or shipped, without isolation from the vacuum, within the container.

### BACKGROUND OF INVENTION

The present invention generally relates to receptacles incorporating thermal insulation, in particular vacuum insulation.

While many inventions of the past have sought to minimize heat conduction through minimizing physical contact points, such as found in corrugated cardboard products, and many inventions of the past have sought to minimize heat conduction through a double walled vacuum structure also with minimal physical contact points, such as found in a standard thermos bottle, no invention of the past has sought to minimize heat conduction through the use of minimized contact points that are actually inside the vacuum with the material that it is desired to insulate itself, eliminating the need for the second wall of the double walled vacuum structure. The result is a far less costly structure to manufacture. Low cost is of the essence, since it is already possible to adequately insulate the materials that it is intended to store or ship, using higher cost methods such as cold packs combined with extruded polystyrene containers.

While at first glance, the present invention would seem to have no utility, it is in fact revolutionary when it becomes clear that the intention is to ship or store materials with low melting points, such as chocolate. The methods of doing so today seem wasteful of materials as above, especially when the desire is primarily only to protect the materials during the few days they will be subject to the high temperatures found within closed delivery trucks.

While there are many materials with low melting points, and thus likely to change form when subject to the high heat found in closed delivery trucks, chocolate is by far the most abundant material that is vulnerable to this. There are many chocolate vendors today who simply do not ship in warm weather, six to eight months out of the year due to product losses, as there was no known way of doing so at low enough cost, previously to the present invention.

While vacuum sealing food using plastic sheeting for storage is nothing new, and food products are vacuum sealed in many ways, most particularly in jars, food products are not currently being vacuum sealed in order to impart insulation. In fact, the current methods would not work for this purpose, since they don't impart any insulation.

Several people have already, however, disclosed the use of plastic sheeting combined with vacuum sealing in order to achieve insulating barriers for other purposes. One method, disclosed by U.S. Pat. No. 4,594,279 to Yoneno, et al. (1986) encloses a mass of flaked perlite in a vacuum sealed pliable container to form an insulating panel. Another method, disclosed by U.S. Pat. No. 5,798,154 to Bryan (1998) utilizes a vacuum sealed metal foil composite plastic wrap to enclose a double walled structural frame. Neither of the above two listed disclosures, however, places the material which it is desired to insulate within the vacuum sealed area itself. Furthermore, both of the above two listed inventions replicate the very same standard double walled vacuum sealed structure that is already commonly used.

In regards to an alternate formation of the present invention in which pyramidal frames are used to accomplish the same objectives as above, U.S. Pat. No. 4,010,865 to Wilgus (1977) discloses a multi-sided collapsible insulated container in which truncated pyramid like shapes are bent together in order to form an insulated storage container. His forms are neither true pyramids nor frame like nor intended to support a vacuum filled pliable envelope.

Furthermore, U.S. Pat. No. 5,346,188 to Rodgers, et al. (1994) discloses a wire assembly using pyramidal frames to support a rebar frame used in a poured concrete foundation. Although similar in using pyramidal frames, albeit of different materials, for maintaining a framework in a spatially separated suspension, the pyramidal frames disclosed are not connected in a grid and function to counteract the force of gravity and not the force exerted by a pliable vacuum filled envelope, as well as having no relation to a shipping or storage container.

Finally, U.S. Pat. No. 4,409,770 to Kawaguchi, et al. (1983) discloses a vacuum insulation spacer utilizing a rectangular grid of crosspiece members that are stacked so as to not overlap at their joints, to elongate the path for any possible heat conduction. Not only is this said vacuum insulation spacer specifically designed to support the walls of the same standard double walled vacuum sealed structure used by everybody else, additionally it utilizes a different method altogether for minimizing heat conduction through the body of a frame.

### SUMMARY OF INVENTION

In the progression of insulating technologies, the present invention is of a new type altogether. Despite the popularity of double walled insulating vacuum structures, we now recognize that the double wall serves no purpose whatsoever as long as the material to be insulated can be kept inside the vacuum. The present invention then could be called a single walled insulating vacuum structure.

A frame that is preferably made of a material with low heat conduction insulating properties and lightweight, although not necessarily so, is constructed of a structural integrity such that the exterior side is able to support under vacuum pressure, a single layer or a laminated film made of any suitable plastic or composite plastic material, while on the interior side, pin like protrusions, or a fine grid, minimize possible contact points for heat conduction, and surround a hollow space that has been relieved of any external pressure by the supporting lightweight frame, wherein the material that it is desired to be insulated can be placed and subsequently vacuum sealed. In an optional configuration of the present invention, the exterior side is supported from collapsing under the vacuum pressure with a bed of pyramid like frames, when the interior material can withstand it, such as with a plastic wrapped candy box, allowing the insulating frame which is formed of a bed of pyramid like frames to be cut to fit as desired from uniform sheets.

The surface area of the physical contact points are naturally minimized by their pin like points, or else a fine grid, so that the comparable surface area for possible heat conduction is no greater, or even less so, than the surface area required to connect double walled insulating vacuum structures at their mouths, as is commonly done in a good quality thermos. The exact same insulating properties of a good quality thermos then, or better, can be achieved with parts that cost only a few cents each through the use of the present invention.

Commonly available laminated composites of plastic film and metallic foil, although preferred in the food packaging industry primarily due to their impermeability to water vapor and oxygen, lend themselves for usage with the present invention as a radiation barrier capable of reflecting away a large percentage of any long wave electromagnetic radiation such as infrared, if they are installed with their reflective coatings facing outwards. Further commonly available enhancements to the present invention would be the additional use of a gas absorbing desiccant or getter, and pre-refrigeration or cold charging of the materials being shipped.

Additionally, a desired benefit of the present invention is that it is also suitable as a storage container, wherein materials can remain vacuum sealed for a lengthy time depending on the permeability of the surrounding pliable envelope, allowing for storage in the same container that will eventually be used for shipping. Furthermore, easily deformed materials, such as food products, can remain stored without any external pressure being exerted on said materials, through the use of several configurations of the present invention, other than from gravity or inertia at the contact points. This is certainly contrary to what occurs during ordinary vacuum sealing using pliable sheeting, which exerts considerable external pressure on the material being vacuum sealed, deforming any number of materials, as well as providing no insulating capabilities.

These and other objectives of the invention will become more apparent to those skilled in the art by reference to the following detailed description when viewed in light of the accompanying drawings therein.

### BRIEF DESCRIPTION OF DRAWINGS

FIGS. 1A-1E are an exploded perspective of the major elements of a single walled insulating vacuum envelope.

FIGS. 2A-2C are an exploded perspective of a single walled insulating vacuum envelope of a circular configuration.

FIG. 3 is a perspective of a gird of pyramidal frames.

FIG. 4 is a perspective of a grid of pyramidal frames that have been bent to fit around a box.

FIG. 5 is a perspective of a four legged clip.

### DETAILED DESCRIPTION

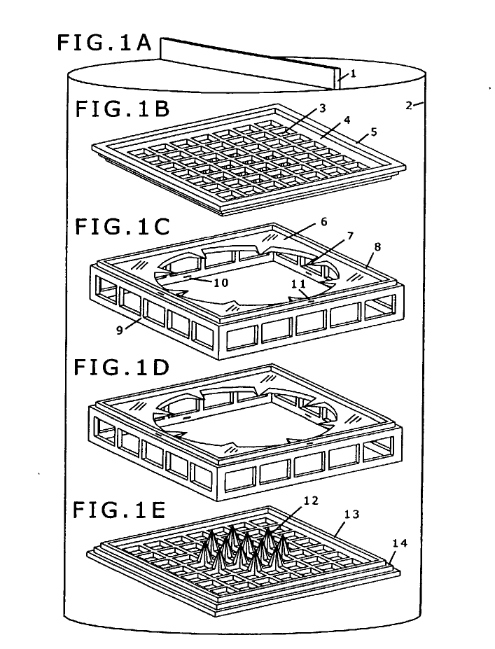

Referring now to the drawings wherein like parts are indicated by like numerals, the numeral 2 indicates a pliable external covering made of a single layer or a laminated film of any suitable plastic or composite plastic material, although any pliable material capable of holding a vacuum sufficiently could conceivably be used. The pliable envelope 2, which it is to be understood completely envelopes the interior pieces FIGS. 1B-1E, is vacuum filled and subsequently sealed.

In particular, a pliable envelope comprised of a composite of metallic foil and plastic film would serve to decrease the permeability of the external pliable envelope 2, thereby holding a stronger vacuum for a longer period of time, and additionally serving to reflect away a certain percentage of any electromagnetic radiation present that is capable of transmission through a vacuum, such as infrared.

It is to be understood, that although any number of means could conceivably be used to seal a vacuum filled pliable envelope, a standard heat sealed strip 1 as created by any number of currently available devices is indicated.

The top piece FIG. 18 and the bottom piece FIG. 7E of the interior frame are identical pieces, one turned 180 degrees around one axis in relation to the other. Furthermore, FIG. 1C and FIG. 1D are also identical pieces, FIG. 1D being indicated solely in order to demonstrate the manner in which the modular interior pieces stack one on top of the other.

Perforations 3 in the identical top and bottom pieces serve a dual function, allowing unobstructed removal of the interior gasses during the vacuum filling process and additionally minimizing the surface contact area between the pliable envelope 2 and the interior construction FIGS. 1B-1E. Although the perforations 3 shown are rectangular, it is understood that perforations of any geometric shape could be used, including round or triangular.

A structural platform 4 surrounding the perforations 3 provides an additional structural support to guard against buckling or bowing of the top FIG. 1B or bottom piece FIG. 1E under the significant pressure created by vacuum filling the pliable envelope 2. The under side of the outer rim 5 creates a platform upon which the underside of the structural wall 9 rests when used with the bottom piece FIG. 1E.

A structural platform 6 serves the dual purpose of not only providing a structural support upon which to place the minimized thermal isolation points 7, but also provides considerable structural support against buckling or bowing to the interior modular pieces FIGS. 1C-1D.

The top face of the intermediate step 14 serves as a platform against which the protruding rim 8 rests, and the protruding rim 13 fits within the protruding rim 8, when used with the top piece FIG. 1B.

Perforations in the structural wall 9 additionally minimize surface contact area between the pliable envelope 2 and the interior construction FIGS. 1B-1E. Although the perforations shown in the structural wall 9 are rectangular, it is understood that perforations of any geometric shape could be used, including round or triangular. The perforations shown in the structural wall 9 are optional, serving only as a secondary means of reducing the possible paths for heat conduction and could be eliminated altogether as shown in FIG. 28.

Although the minimized thermal isolation points 7 are shown as being pyramidal in shape, it is explicitly understood that many conceivable shapes could be used for this purpose, specifically rods or rectangles, although since these points represent the primary path for heat conduction to the interior material being stored or shipped, the design would suffer given additional surface area in contact, albeit that that might be acceptable, or even required, for particular materials. Furthermore, although the minimized thermal isolation points 7 are shown extending to sharp points, the tips could be rounded with little loss in performance, microscopically this is what must occur in any case. It is also understood that both the number of minimized thermal isolation points 7 and their precise locations could vary greatly from the configuration currently shown.

Additionally, there are minimized thermal isolation points 12 connected, to the top piece FIG. 1B and the bottom piece FIG. 1E. Although the minimized thermal isolation points 12 are shown as being formed of dual perpendicular pyramids it is understood that many conceivable shapes could be used for this purpose, specifically rods or rectangles. It is also understood that both the number of minimized thermal isolation points 12 and their precise locations could vary greatly from the configuration currently shown.

The underside of structural wall 9, although by itself relatively un-reinforced through the proximity of additional supporting structures, in all cases transfers the force imparted upon it to the structural support of an adjoining piece via a protruding rim 8 when attached to a connecting modular interior piece FIGS. 1C-1D or through the protruding rim 14 when attached to a bottom piece FIG. 1E. Of course, this imparts a great deal of structural strength to the interior frame.

Although the pressure imparted by the vacuum filled envelope will serve to hold the pieces firmly together with no need of any additional supports, in order to temporarily hold the pieces together during construction, small indentations 10 and small protrusions 11 are provided for the convenience of the constructor in order to allow the modular pieces to snap together using a compression fitting as is already commonly known how to do.

It is understood that although the modular pieces shown in FIGS. 1B-1E are rectangular in cross section, a cross section of any geometric shape capable of being represented on a two dimensional plane could be used, for example triangular, circular or hexagonal.

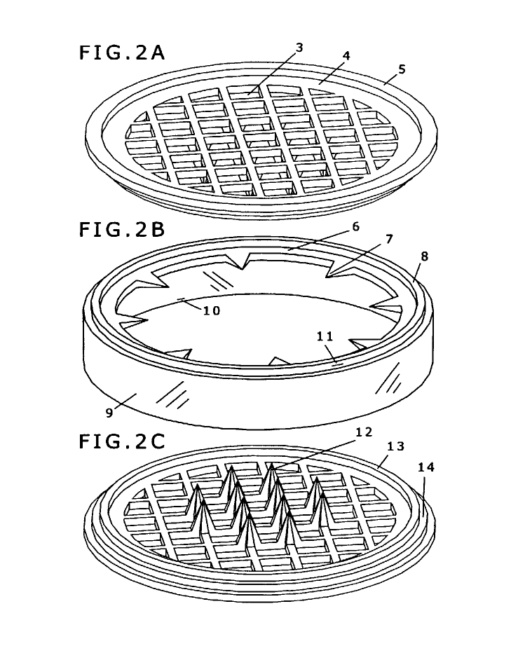

FIGS. 2A-2C represent an alternative configuration of FIGS. 1B-1E that is identical in every way except that it has been constructed of modular pieces that are circular in cross section rather than rectangular.

Furthermore, although it would be theoretically possible to form the constructions shown in FIGS. 1B-1E and FIGS. 2A-2C from one piece and have the design suffer no differences whatsoever, as opposed to using modular pieces, for all practical purposes, the modular form is likely required when using modern plastic molding techniques to form the parts. Modular pieces as well provide an easy way to form the correct length.

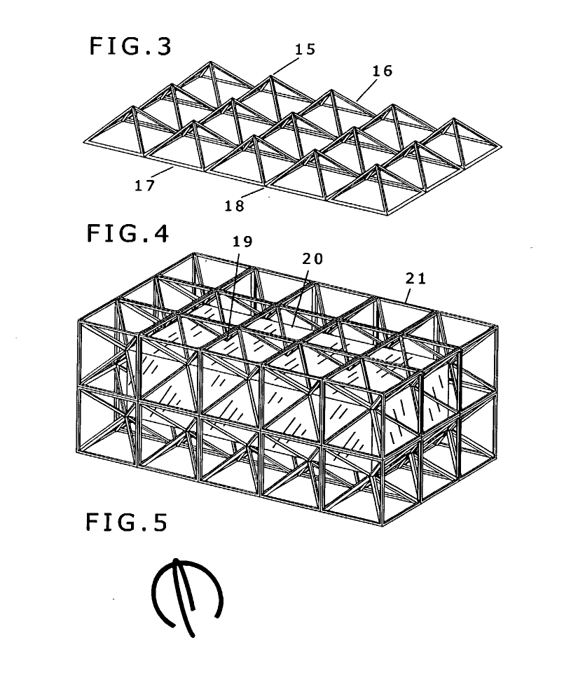

An alternate method of constructing a frame suitable of supporting a pliable envelope under vacuum pressure while minimizing the surface area of physical contact between said frame and the material being shipped or stored inside the vacuum, for the purpose of efficiently minimizing possible pathways for thermal conduction, is shown in FIG. 3. Because the material being shipped or stored using this said alternate method must necessarily serve as an integral part of the structural support, given a lightweight structural frame, this said alternate method is only suitable for materials that can withstand the pressure being exerted by a pliable envelope under vacuum pressure, such as most materials can withstand when stored within a suitable container, such as a plastic wrapped candy box.

A grid of interconnected pyramidal frames as shown in FIG. 3 is constructed such that the said interconnected pyramidal frames attach to each other at all four sides of their square pyramid base 17, to the extent that the grid continues. A minimized thermal isolation point 15 is naturally created at the top most point of each pyramidal frame.

Each said interconnected pyramidal frame is constructed of a sufficiently ductile plastic and interconnected along each side of each square pyramid base 17 by a thin section of said ductile plastic in such a way that a natural hinge 18 is created along each side of each interconnected pyramidal base, to the extent that the grid continues.

The upright member of each pyramidal frame 16 extends upwards at an angle of 35.26438967 degrees from each corner of the square pyramid base 17 towards the pyramid's top most point, this said angle, when viewed from the side, will then form an angle of 45 degrees, allowing the interconnected pyramidal pieces to form 90 degree angles when bent along their ductile plastic hinges 18 so that the upright members of the pyramidal frames 16 meet.

The construction pictured in FIG. 4 can easily be made by taking a piece of grid as depicted by FIG. 3 that is ten by seven pyramidal frames in extent. If the pyramidal frames are numbered so that each row is numbered one to ten and each column is numbered one to seven, rows listed before columns, then the construction shown in FIG. 4 can easily be formed by clipping out and discarding the following pyramidal frames (1,1) (5,1) (6,1) (10,1) (1,7) (5,7) (6,7) (10,7) and then bending the construction in order to form 90 degree angles between rows 1,2 rows 4,5 rows 6,7 and rows 9,10 and between columns 1,2 and 6,7 at which time the construction will be complete exactly as shown in FIG. 4.

It is noteworthy to comment that the construction shown in FIG. 4 continues to contact the box 20 that is shown situated inside the exterior framework 27 by only pin like points 19 with minimal surface area contact maintained.

A four legged clip formed of two perpendicularly interconnected truncated elliptical or circular frames FIG. 5, said legs of which are any geometric shape including circular, rectangular, triangular or elliptical in cross section can be used to hold the unsupported side edges or corner edges of the construction shown in FIG. 4 temporarily together for the convenience of the constructor. Although alternately, the pliable vacuum filled envelope would serve to pull the pieces into place in any case, with or without the use of the four legged clips FIG. 5.

Although the present invention has fully been described in connection with the illustrative examples, it is to be noted that various changes and modifications can be readily conceived by those skilled in the art. Such changes and modifications are to be understood as included within the scope of the present invention as defined by the appended claims, unless they depart therefrom.

1. a vacuum filled structural frame enclosing materials to be stored or shipped without isolation from the vacuum, supporting an external pliable covering, for maintaining said inside materials and said external pliable covering in spaced apart relationship for the purpose of insulating said inside materials from thermal conduction.

2. The vacuum filled structural frame of claim 1 wherein said structural frame includes means for minimizing the surface area of physical contact points for thermal conduction to the enclosed materials being stored or shipped through the use of projecting supports.

3. The vacuum filled structural frame of claim 1 wherein said structural frame includes means for minimizing the surface area of physical contact points for thermal conduction to the enclosed materials being stored or shipped through the use of a grid.

4. The vacuum filled structural frame of claim 2 wherein said projecting supports are pyramidal in form.

5. The vacuum filled structural frame of claim 2 wherein said projecting supports are rod like in form.

6. The vacuum filled structural frame of claim 2 wherein said projecting supports are rectangular in form.

7. The vacuum filled structural frame of claim 2 wherein said structural frame is capable of supporting the external pliable covering under vacuum pressure completely so that none of the force being imparted by the vacuum pressure on the external pliable covering is transferred through the physical supports of the said vacuum filled structural frame towards the material being stored or shipped in the interior.

8. The vacuum filled structural frame of claim 7 wherein the force being imparted by the vacuum pressure on the external pliable covering is prevented from being transferred through the physical supports of said structural frame through the use of periodically spaced structural platforms or ribs.

9. The vacuum filled structural frame of claim 7 wherein said structural frame is constructed of modular pieces.

10. The modular pieces of claim 9 wherein said modular pieces fit together through the use of a protruding rim on one side and an extended structural wall on the other side, the exterior circumference of said protruding rim being identical in shape and length, to the interior circumference of said extended structural wall.

11. The modular pieces of claim 9 wherein the top and bottom piece are designed so that they are indistinguishable from each other through the use of a three stepped rim.

12. The modular pieces of claim 9 wherein said modular pieces have been constructed so as to snap together using compression fittings through the use of interconnecting indentations and protrusions.

13. A four legged clip formed of two perpendicularly interconnected truncated elliptical or circular frames, that are any geometric shape including circular, rectangular, triangular or elliptical in cross section of the said elliptical or circular frame.

14. The vacuum filled structural frame of claim 1 wherein said structural frame is comprised of a grid of interconnected pyramidal frames that attach to each other at all four sides of their bases, to the extent that the grid continues.

15. The vacuum filled structural frame of claim 14 wherein each pyramidal frame is constructed of a sufficiently ductile plastic or composite plastic material and interconnected along each side of each base by a thin section of said ductile plastic in such a way that a natural hinge is created along each side of each interconnected pyramidal base, to the extent that the grid continues.

16. The vacuum filled structural frame of claim 14 wherein each upright member of each pyramidal frame extends upwards at an angle of 35.26438967 degrees from each corner of a square pyramid base towards the pyramid's top most point, said angle, when viewed from the side, then forming an angle of 45 degrees, allowing the interconnected pyramidal pieces to form 90 degree angles when connected perpendicularly to like pyramidal frames.

17. The vacuum filled structural frame of claim 14 wherein said structural frame is comprised of uniform cut to fit sheets.
